(19) United States
(12) Patent Application Publication
(10) Pub. No.: US 2012/0181063 A1
(43) Pub. Date: Jul. 19, 2012

(54) TRANSPARENT CONDUCTIVE FILM AND TOUCH PANEL

(75) Inventors: Kazuhiro Nakajima, Ibaraki-shi (JP); Hideo Sugawara, Ibaraki-shi (JP); Tomotake Nashiki, Ibaraki-shi (JP)

(73) Assignee: Nitto Denko Corporation, Ibaraki-shi, Osaka (JP)

(21) Appl. No.: 13/498,688

(22) PCT Filed: Sep. 28, 2010
(86) PCT No.: PCT/JP2010/066818

§ 371 Date: Mar. 28, 2012

(30) Foreign Application Priority Data
Sep. 30, 2009 (JP) 2009-228540

(51) Int. Cl. H01B 7/02

(52) U.S. Cl. 174/133 R

(57) ABSTRACT

The present invention relates to a transparent conductive film in which a transparent conductive layer is patterned and that is capable of suppressing deterioration of the appearance due to the difference in hues of reflected light between the pattern portion and the portion directly under the pattern opening portion, and a touch panel that uses it. In the transparent conductive film (10) of the present invention, a first transparent dielectric layer (2) and a transparent conductive layer (4) are formed on a transparent base material (1) in this order. It is preferable that a relationship 0≦|a*_{P}−a*_{O}|≦4.00 is satisfied and a relationship 0≦|b*_{P}−b*_{O}|≦5.00 is satisfied where a hue a* value and a hue b* value of reflected light when the pattern portion (P) is irradiated with white light are a*_{P} and b*_{P}, respectively, and a hue a* value and a hue b* value of reflected light when a portion directly under the pattern opening portion (O) is irradiated with white light are a*_{O} and b*_{O}, respectively.

### TECHNICAL FIELD

The present invention relates to a transparent conductive film and a touch panel that uses it.

### BACKGROUND ART

A transparent conductive member that is transparent in the visible light region and that has conductivity has been used for preventing static charge, shielding an electromagnetic wave, etc. in articles in addition to being used as a transparent electrode in displays such as a liquid crystal display and an electroluminescent display, and touch panels.

Concerning conventional transparent conductive components, the so-called conductive glass is well known, which includes a glass member and an indium oxide thin film formed thereon. Since the base material of the conductive glass is made of glass, however, it has low flexibility or workability and is difficult to be used in some applications. In recent years, therefore, transparent conductive films using various types of plastic films such as polyethylene terephthalate films as their substrates have been used, because of their advantages such as good impact resistance and light weight as well as flexibility and workability.

A known transparent conductive film for detecting input positions in touch panels and the like includes a transparent conductive layer having a predetermined pattern. However, such a patterned transparent conductive layer may produce a clear difference between the patterned portion and the pattern opening portion (non-patterned portion) so that a display device produced therewith may have a poor appearance.

In order to improve the appearance when a transparent conductive layer is patterned, forming a transparent dielectric layer between a transparent base material and the transparent conductive layer is proposed in Patent Document 1 for example.

### PRIOR ART DOCUMENT

### Patent Document

Patent Document 1: Japanese Patent Application Laid-Open No. 2009-76432.

### DISCLOSURE OF THE INVENTION

### Problems to be Solved by the Invention

However, the boundary between the pattern portion and the pattern opening portion in the conventional transparent conductive film becomes visible due to the difference in hues of reflected light between the pattern portion and a portion directly under the pattern opening portion, and as a result, there is a concern that the appearance as a display element becomes worse.

The present invention provides a transparent conductive film in which a transparent conductive layer is patterned and that is capable of suppressing deterioration of the appearance due to the difference in hues of reflected light between the pattern portion and the portion directly under the pattern opening portion, and a touch panel that uses it.

### Means for Solving the Problems

In order to achieve the above-described object, the transparent conductive film of the present invention is a transparent conductive film in which a first transparent dielectric layer and a transparent conductive layer are formed on a transparent base material in this order, wherein a pattern portion and a pattern opening portion are formed on the transparent conductive layer by patterning, and a relationship 0≦|a*_{P}−a*_{O}|≦4.00 is satisfied and a relationship 0≦|b*_{P}−b*_{O}|≦5.00 is satisfied where a hue a* value and a hue b* value of reflected light when the pattern portion is irradiated with white light are a*_{P} and b*_{P}, respectively, and a hue a* value and a hue b* value of reflected light when a portion directly under the pattern opening portion is irradiated with white light are a*_{O} and b*_{O}, respectively. The “reflected light” indicates reflected light when the pattern portion or the portion directly under the pattern opening portion is irradiated with white light from a tungsten iodine lamp from the transparent conductive layer side at an incident angle of 10°.

According to the transparent conductive film of the present invention, because the difference in hues of reflected light between the pattern portion and the pattern opening portion can be suppressed, it becomes difficult to distinguish between the pattern portion and the pattern opening portion, and a transparent conductive film having a good appearance can be provided.

The transparent conductive film of the present invention preferably further has a second transparent dielectric layer that is provided between the first transparent dielectric layer and the transparent conductive layer, and that has a refractive index different from that of the first transparent dielectric layer. Because the difference in reflectance between the pattern portion and the portion directly under the pattern opening portion can be reduced, the difference between the pattern portion and the pattern opening portion can be further suppressed.

When the transparent conductive film of the present invention further has the second transparent dielectric layer, the optical thickness of the first transparent dielectric layer is preferably 3 to 45 nm, the optical thickness of the second transparent dielectric layer is preferably 3 to 50 nm, the optical thickness of the transparent conductive layer is preferably 20 to 100 nm, and a relationship n1<n2 is preferably satisfied where the refractive index of the second transparent dielectric layer is n1 and the refractive index of the transparent conductive layer is n2. With this configuration, the difference in hues of reflected light between the pattern portion and the portion directly under the pattern opening portion can be further suppressed. Because the difference in reflectance between the pattern portion and the portion directly under the pattern opening portion can be further decreased, the difference between the pattern portion and the pattern opening portion can be even further suppressed. The “optical thickness” of each layer corresponds to a value obtained by multiplying the physical thickness of each layer (the thickness as measured with a thickness gauge or the like) by the refractive index of the layer. In an embodiment of the invention, the refractive index is determined with light at a wavelength of 589.3 nm. In the specification, the physical thickness is also simply referred to as “thickness.”

A pattern portion and a pattern opening portion are preferably formed by patterning the second transparent dielectric layer. With this configuration, the difference in hues of reflected light between the pattern portion and the portion directly under the pattern opening portion can be further suppressed. In this case, the pattern portion of the transparent conductive layer and the pattern portion of the second transparent dielectric layer are preferably matched to each other. With this configuration, the difference in hues of reflected light between the pattern portion and the portion directly under the pattern opening portion can be even further suppressed, and the difference in reflectance between the pattern portion and the portion directly under the pattern opening portion can be further decreased.

The invention is also directed to a touch panel including the transparent conductive film of the invention stated above. The touch panel of the invention can produce the same advantageous effect as the transparent conductive film of the invention.

### BRIEF DESCRIPTION OF THE DRAWINGS

FIG. 1 is a cross section view showing one example of the transparent conductive film of the present invention.

FIG. 2 is a cross section view showing another example of the transparent conductive film of the present invention.

FIGS. 3A to 3C are cross section views showing other examples of the transparent conductive film of the present invention.

### MODE FOR CARRYING OUT THE INVENTION

The embodiment of the present invention is explained below by referring to the drawings. The same reference numerals are appended to the same configuration elements, and repeated explanation is omitted.

FIG. 1 is a cross section view showing one example of the transparent conductive film of the present invention. A transparent conductive film 10 shown in FIG. 1 has a transparent base material 1, a first transparent dielectric layer 2, a second transparent dielectric layer 3, and a transparent conductive layer 4 that are formed on the transparent base material 1 in order. The transparent conductive layer 4 and the second transparent dielectric layer 3 are patterned, and a pattern portion P and a pattern opening portion O are formed on each of the layers. The pattern portion P of the transparent conductive layer 4 and the pattern portion P of the second transparent dielectric layer 3 are matched to each other.

The transparent conductive film 10 satisfies the relationship 0≦|a*_{P}−a*_{O}|≦4.00 and the relationship 0≦|b*_{P}−b*_{O}|≦5.00 where a*_{P} and b*_{P} are a hue a* value and a hue b* value of reflected light when the pattern portion P of the transparent conductive layer 4 is irradiated with white light, respectively, and a*_{O} and b*_{O} are a hue a* value and a hue b* value of reflected light when the portion directly under the pattern opening portion O of the transparent conductive layer 4 is irradiated with white light, respectively. With this, the difference in hues of reflected light between the pattern portion P and the portion directly under the pattern opening portion O can be suppressed, and therefore it becomes difficult to distinguish between the pattern portion P and the pattern opening portion O, and the transparent conductive film 10 having a good appearance can be provided. “The portion directly under the pattern opening portion O” in the case of FIG. 1 indicates the surface of the first transparent dielectric layer 2 that faces to the pattern opening portion O. In order to further suppress the difference in hues of reflected light in the transparent conductive film 10, it is preferable to satisfy a relationship 0≦|a*_{P}−a*_{O}|≦3.00 and a relationship 0≦|b*_{P}−b*_{O}|≦4.50. From the same viewpoint, the value of |a*_{P}−a*_{O}| is more preferably 0 to 2.00, further preferably 0 to 1.00, and furthermore preferably 0 to 0.70.

From the viewpoint of further suppressing the difference in hues of reflected light between the pattern portion P and the portion directly under the pattern opening portion O and the viewpoint of further suppressing the difference between the pattern portion P and the pattern opening portion O by decreasing the difference in reflectance between the pattern portion P and the portion directly under the pattern opening portion O in the transparent conductive film 10, the transparent conductive film 10 preferably satisfies the following condition. That is, in the transparent conductive film 10, it is preferable that the optical thickness of the first transparent dielectric layer 2 is 3 to 45 nm, the optical thickness of the second transparent dielectric layer 3 is 3 to 50 nm, the optical thickness of the transparent conductive layer 4 is 20 to 100 nm, and the relationship n1<n2 is satisfied where n1 is the refractive index of the second transparent dielectric layer 3 and n2 is the refractive index of the transparent conductive layer 4. A more preferable range of the optical thickness of each layer is 3 to 22 nm for the first transparent dielectric layer 2, 3 to 40 nm for the second transparent dielectric layer 3, and 20 to 75 nm for the transparent conductive layer 4.

There is no particular limitation to the transparent base material 1, and various types of plastic films having transparency may be used. Examples of the material for the transparent base material 1 include polyester resins, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polycarbonate resins, and polyolefin resins are preferred.

Examples thereof also include polymer films as disclosed in JP-A No. 2001-343529 (WO01/37007) and a resin composition that contains a thermoplastic resin having a side chain of a substituted and/or unsubstituted imide group and a thermoplastic resin having a side chain of substituted and/or unsubstituted phenyl and nitrile groups. Specifically, a polymer film of a resin composition containing an alternating copolymer made of isobutylene and N-methylmaleimide, and an acrylonitrile-styrene copolymer may be used.

The transparent base material 1 preferably has a thickness of from 2 to 200 μm, more preferably from 2 to 100 μm. In this range, thinning of the transparent conductive film 10 becomes easy, while a certain mechanical strength of the transparent base material can be ensured.

The surface of the transparent base material 1 may be previously subject to sputtering, corona discharge treatment, flame treatment, ultraviolet irradiation, electron beam irradiation, chemical treatment, etching treatment such as oxidation, or undercoating treatment such that the adhesion of the first transparent dielectric layer 2 formed thereon to the transparent base material 1 can be improved. If necessary, the transparent base material 1 may also be subjected to dust removing or cleaning by solvent cleaning, ultrasonic cleaning or the like, before the first transparent dielectric layer 2 is formed.

The first and second transparent dielectric layers 2 and 3 may each be made of an inorganic material, an organic material or a mixture of an inorganic material and an organic material. Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. Besides the above, a complex oxide containing at least indium oxide and cerium oxide may also be used. Examples of the organic material include acrylic resins, urethane resins, melamine resins, alkyd resins, siloxane polymers, and organosilane condensates as well as a mixture of these.

Particularly, the second transparent dielectric layer 3 is preferably made of an inorganic material. According to this feature, photo-deterioration of the second transparent dielectric layer can be prevented so that the durability of the transparent conductive film 10 can be improved. In this case, the inorganic material is preferably SiO₂. Since SiO₂ is highly resistant to acid in addition to being inexpensive and easily-available, it can prevent degradation of the second transparent dielectric layer 3 when the transparent conductive layer 4 is pattered by etching with acid.

The first and second transparent dielectric layers 2 and 3 provided between the transparent base material 1 and the transparent conductive layer 4 do not function as conductive layers. In other words, the first and second transparent dielectric layers 2 and 3 are provided as dielectric layers capable of insulating pattern portions P, P of the transparent conductive layer 4 from one another. Therefore, the first and second transparent dielectric layers 2 and 3 each typically have a surface resistance of 1×10⁶ Ω/square or more, preferably 1×10⁷ Ω/square or more, more preferably 1×10⁸ Ω/square or more. The surface resistance of the first and second transparent dielectric layers 2 and 3 does not have any particular upper limit. While the surface resistance of the first and second transparent dielectric layers 2 and 3 may generally has an upper limit of about 1×10¹³ Ω/square, which corresponds to a measuring limit, it may be higher than 1×10¹³ Ω/square.

Examples of materials that may be used to form the transparent conductive layer 4 include, but are not limited to, oxides of at least one metal (or semimetal) selected from the group consisting of indium, tin, zinc, gallium, antimony, titanium, silicon, zirconium, magnesium, aluminum, gold, silver, copper, palladium, and tungsten. Such oxides may be optionally added with any metal atom selected from the above group or any oxide thereof. For example, indium oxide containing with tin oxide or tin oxide containing with antimony is preferably used.

The refractive index (n0) of the first transparent dielectric layer 2 is preferably from 1.3 to 2.5, more preferably from 1.4 to 2.3. The refractive index (n1) of the second transparent dielectric layer 3 is preferably from 1.3 to 2.0, more preferably from 1.3 to 1.6. The refractive index (n2) of the transparent conductive layer 4 is preferably from 1.9 to 2.1. When each layer has a refractive index in the above range, the difference in hues of reflected light between the pattern portion P and the portion directly under the pattern opening portion O can be effectively reduced, while transparency can be ensured.

From the viewpoints of uniformity of thickness, prevention of crack generation, and improvement of transparency, the thickness of the first transparent dielectric layer 2 is preferably 2 to 30 nm and more preferably 2 to 12 nm. From the same viewpoints, the thickness of the second transparent dielectric layer 3 is preferably 2 to 30 nm. From the same viewpoints, the thickness of the transparent conductive layer 4 is preferably 10 to 50 nm, more preferably 10 to 40 nm, and further preferably 10 to 30 nm.

An example of a method for manufacturing the transparent conductive film 10 is a method including a step of forming the first transparent dielectric layer 2, the second transparent dielectric layer 3, and the transparent conductive layer 4 on one side of the transparent base material 1 in this order from the transparent base material 1 side, a step of patterning the transparent conductive layer 4 by etching with an etchant, and a step of patterning the second transparent dielectric layer 3 by etching with an etchant.

Examples of methods for forming each of the first transparent dielectric layer 2, the second transparent dielectric layer 3, and the transparent conductive layer 4 include a vacuum deposition method, a sputtering method, an ion plating method, a coating method and so on. Any appropriate method may be used depending on the type of the material and the desired thickness.

Upon the etching of the transparent conductive layer 4, the transparent conductive layer 4 may be covered with a patterning mask and etched with an etchant such as an acid. The acid may be an inorganic acid such as hydrochloric acid, hydrobromic acid, sulfuric acid, nitric acid, or phosphoric acid, an organic acid such as acetic acid, any mixture thereof, or an aqueous solution of any of the foregoing.

When etching the second transparent dielectric layer 3, the transparent conductive layer 4 may be covered with the same patterning mask as the case that the transparent conductive layer 4 is etched, and then the second transparent dielectric layer 3 may be etched with an etchant. Because an inorganic substance such as SiO₂ can be suitably used for the second transparent dielectric layer 3 as described above, alkali can be suitably used as an etchant. Examples of alkali include solutions of sodium hydroxide, potassium hydroxide, ammonia, and tetramethyl ammonium hydroxide, and mixtures thereof.

After the transparent conductive layer 4 is patterned, a heat treatment may be performed on the patterned transparent conductive layer 4 as necessary. This is because the constituting components of the transparent conductive layer 4 are crystallized by the heat treatment and transparency and conductivity can be improved. The heating temperature at this time is in a range of 100 to 150° C. for example, and the heating time is in a range of 15 to 180 minutes for example.

The transparent conductive layer 4 and the second transparent dielectric layer 3 may be patterned in any of various forms such as stripes depending on the intended use of the transparent conductive film 10.

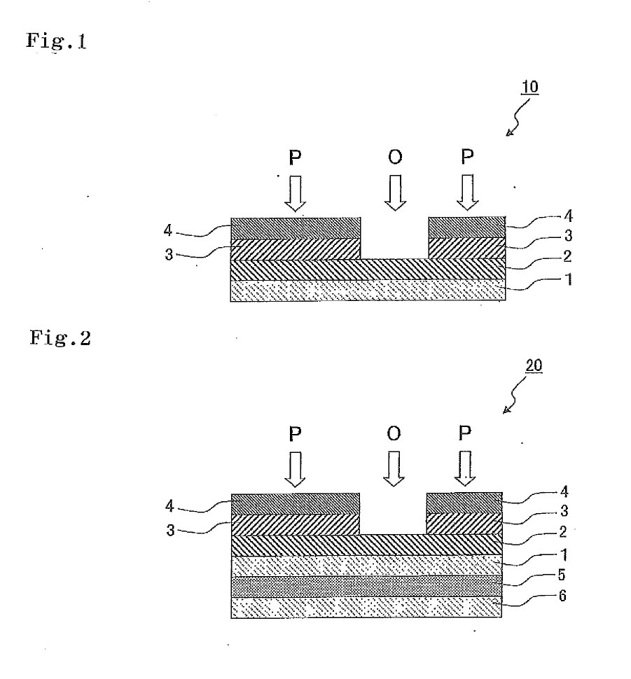

A transparent conductive film that is another example of the present invention is then explained by referring to FIG. 2. As shown in FIG. 2, in a transparent conductive film 20, a transparent substrate 6 is provided on the underside in the drawing (that is, the surface opposite from the first transparent dielectric layer 2 in the transparent base material 1) of the transparent base material 1 of the transparent conductive film 10 described above with a transparent pressure-sensitive adhesive layer 5 interposed therebetween.

Any transparent pressure-sensitive adhesive may be used for the transparent pressure-sensitive adhesive layer 5 without limitation. For example, the pressure-sensitive adhesive may be appropriately selected from transparent adhesives based on polymers such as acrylic polymers, silicone polymers, polyester, polyurethane, polyamide, polyvinyl ether, vinyl acetate-vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

The transparent pressure-sensitive adhesive layer 5 is generally made from a pressure-sensitive adhesive solution (with a solids content of about 10 to about 50% by weight) containing a base polymer or a composition thereof dissolved or dispersed in a solvent. The solvent to be used may be appropriately selected from an organic solvent such as toluene or ethyl acetate or water or the like depending on the type of the pressure-sensitive adhesive.

The transparent substrate 6 preferably has a thickness of from 10 to 300 μm, more preferably from 20 to 250 μm. When the transparent substrate 6 is formed of a plurality of substrate films, each substrate film preferably has a thickness of from 10 to 200 μm, more preferably from 20 to 150 μm. The transparent substrate 6 or the substrate film may be made of the same material as the transparent base material 1 described above.

The transparent substrate 6 may be bonded to the transparent base material 1 by a process including forming the transparent pressure-sensitive adhesive layer 5 on the transparent substrate 6 and then attaching the transparent base material 1 thereto or contrarily by a process including forming the transparent pressure-sensitive adhesive layer 5 on the transparent base material 1 and then attaching the transparent substrate 6 thereto. The latter process is more advantageous in terms of productivity, because it allows continuous formation of the transparent pressure-sensitive adhesive layer 5 on the transparent base material 1 used in the form of a roll. Alternatively, the transparent substrate 6 may be formed by sequentially laminating a plurality of substrate films with a transparent pressure-sensitive adhesive layer or layers (not shown) on the transparent base material 1. The transparent pressure-sensitive adhesive layer for use in laminating substrate films may be the same as the transparent pressure-sensitive adhesive layer 5 described above.

After the bonding of the transparent substrate 6, for example, the transparent pressure-sensitive adhesive layer 5 has a cushion effect and thus can function to improve the scratch resistance of the transparent conductive layer 4 formed on one side of the transparent base material 1 or to improve the tap properties thereof for touch panels, such as so called pen input durability and surface pressure durability. In terms of performing this function better, it is preferred that the elastic modulus of the transparent pressure-sensitive adhesive layer 5 is set in the range of 1 to 100 N/cm² and that its thickness is set at 1 μm or more (preferably in the range of 5 to 100 μm). If the thickness is as described above, the effect can be sufficiently produced, and the adhesion between the transparent substrate 6 and the transparent base material 1 can also be sufficient.

The transparent substrate 6 bonded through the transparent pressure-sensitive adhesive layer 5 imparts good mechanical strength to the transparent base material 1 to improve the pen input durability or the contact pressure durability.

If necessary, a hard coat layer (not shown) may also be formed on the outer surface of the transparent substrate 6 in order to protect the outer surface. For example, the hard coat layer is preferably made of a cured resin film such as a melamine, urethane, alkyd, acrylic, or silicone resin film. The hard coat layer preferably has a thickness of from 0.1 to 30 μm in view of hardness and the prevention of cracking or curling.

The transparent conductive film that is one example of the present invention is explained above. However, the present invention is not limited to the above-described embodiment. In the above-described embodiment, for example, a case is exemplified in which the second transparent dielectric layer is patterned. However, the second transparent dielectric layer may not be patterned.

The second transparent dielectric layer may not be provided in the present invention. In this case, a constituting material is preferably selected so that the relationship n0<n2 is satisfied where n0 is the refractive index of the first transparent dielectric layer and n2 is the refractive index of the transparent conductive layer.

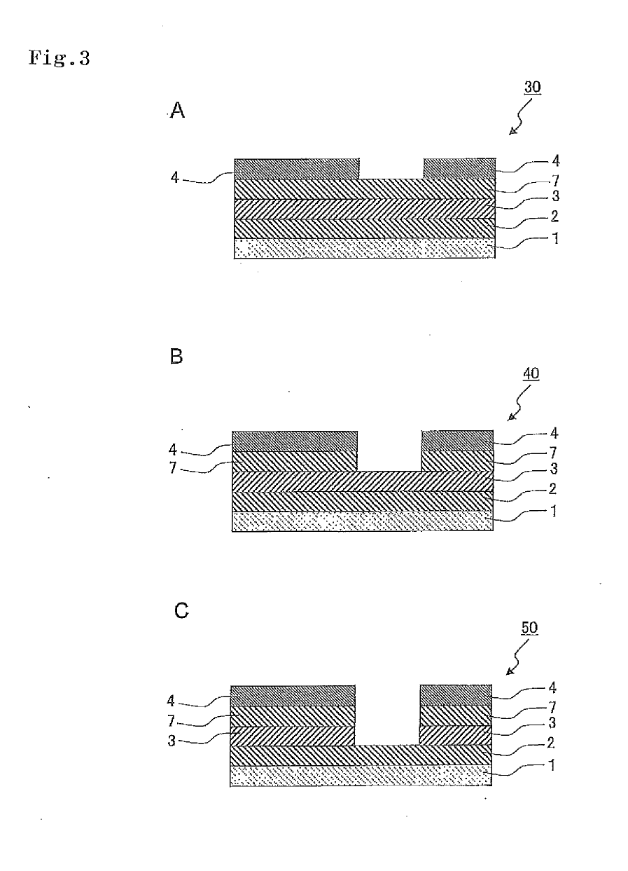

As shown in FIGS. 3A to 3C, a third transparent dielectric layer 7 may be formed between the second transparent dielectric layer 3 and the transparent conductive layer 4 in the present invention. In this case, each of the transparent dielectric layers may not be patterned as in a transparent conductive film 30 in FIG. 3A, and a part of the transparent dielectric layers may be patterned as in FIGS. 3B and 3C. That is, the third transparent dielectric layer 7 may be patterned as in a transparent conductive film 40 in FIG. 3B, and the second and third transparent dielectric layers 3 and 7 may be patterned as in a transparent conductive film. 50 in FIG. 3C. Four or more transparent dielectric layers may be provided even though they are not shown in the drawings.

The transparent conductive film of the present invention may be provided with an antiglare layer or an antireflection layer for the purpose of increasing visibility. When the transparent conductive film is used for a resistive film type touch panel, an antiglare layer or an antireflection layer may be formed on the outer surface of the transparent substrate (on the side opposite to the pressure-sensitive adhesive layer) similarly to the hard coat layer. An antiglare layer or an antireflection layer may also be formed on the hard coat layer. On the other hand, when the transparent conductive film is used for a capacitive type touch panel, an antiglare layer or an antireflection layer may be formed on the transparent conductive layer.

For example, the material to be used to form the antiglare layer may be, but not limited to, an ionizing radiation-curable resin, a thermosetting resin, a thermoplastic resin, or the like. The thickness of the antiglare layer is preferably from 0.1 to 30 μm.

The antireflection layer may use titanium oxide, zirconium oxide, silicon oxide, magnesium fluoride, or the like. In order to produce a more significant antireflection function, a laminate of a titanium oxide layer (s) and a silicon oxide layer (s) is preferably used. Such a laminate is preferably a two-layer laminate comprising a high-refractive-index titanium oxide layer (refractive index: about 2.35), which is formed on the transparent substrate or the hard coat layer, and a low-refractive-index silicon oxide layer (refractive index: about 1.46), which is formed on the titanium oxide layer. Also preferred is a four-layer laminate which comprises the two-layer laminate and a titanium oxide layer and a silicon oxide layer formed in this order on the two-layer laminate. The antireflection layer of such a two- or four-layer laminate can evenly reduce reflection over the visible light wavelength range (380 to 780 nm).

The transparent conductive film of the present invention can be suitably applied to a touch panel of a capacitance type or a resistance film type, for example.

### EXAMPLES

Examples of the present invention are explained below together with comparative examples. However, the present invention shall not be interpreted as being limited to the following examples. Evaluation of the examples and the comparative examples was performed with the methods shown below.

### <Refractive Index of Each Layer>

The refractive index of each layer was measured under a condition of 25° C. with an Abbe refractometer manufactured by Atago Co., Ltd. according to the measurement method specified for the refractometer, while a measurement light beam (wavelength: 589.3 nm) was applied to the surface of each object being measured.

### <Thickness of Each Layer>

The thickness of the transparent base material was measured with a microgauge type thickness gauge manufactured by Mitutoyo Corporation. The thicknesses of other layers were measured by observing their cross-sections with a transmission electron microscope H-7650 manufactured by Hitachi, Ltd.

### <Visible Light Transmittance>

The visible light transmittance was measured at a light wavelength of 550 nm using a spectroscopic analyzer UV-240 manufactured by Shimadzu Corporation.

### <Difference in Reflectance>

Reflection spectra were measured at an incidence angle of 10° using a spectrophotometer U-4100 manufactured by Hitachi, Ltd. in a measurement mode with an integrating sphere, and the average reflectance of the pattern portion and the average reflectance of the portion directly under the pattern opening portion were each calculated in the wavelength range of from 450 to 650 nm. The absolute value of the difference in reflectance between the pattern portion and the portion directly under the pattern opening portion was calculated from these average reflectance values. A light-blocking layer was formed on the back side (the transparent base material side) of the transparent conductive film (sample) using a black spray paint, and the measurement was performed under such conditions that reflection from the back side of the sample and incidence of light from the back side were almost prevented.

### <Difference in Hues>

The pattern portion or the portion directly under the pattern opening portion was irradiated with white light from the transparent conductive layer side at an incident angle of 10°, and the hue a* value and hue b* value of the reflected light having a wavelength of 380 to 780 nm at that time were measured using a spectrophotometer U4100 manufactured by Hitachi, Ltd. Δa* and Δb* were calculated using the following formula from the obtained measured values. Calculation of a reflected color was performed under a condition of a viewing angle of 2° by adopting standard light D65 regulated by JIS Z 8720. In the following formula, a*_{P} and b*_{P} indicate the hue a* value and the hue b* value of the reflected light when the pattern portion was irradiated with white light, respectively, and a*_{O} and b*_{O} indicate the hue a* value and the hue b* value of reflected light when the portion directly under the pattern opening was irradiated with white light, respectively.

Δa*=|a*_{P}−a*_{O}|

Δb*=|b*_{P}−b*_{O}|

### <Evaluation of Appearance>

A sample was placed on a black plate under sunlight so that the transparent conductive layer side was faced up, and the evaluation of the appearance was performed visually with the following criteria.

A: Difficult to distinguish between the pattern portion and the pattern opening portion

B: Slightly distinguishable between the pattern portion and the pattern opening portion

C: Clearly distinguishable between the pattern portion and the pattern opening portion

### Example 1

### (Formation of First Transparent Dielectric Layer)

A first transparent dielectric layer (refractive index n0=1.54, thickness: 4 nm) was formed by applying a thermosetting type resin of a melamine resin:an alkyd resin:an organosilane condensate (weight ratio of 2:2:1) on one surface of a transparent base material (refractive index nf=1.66) consisting of a polyethylene terephthalate film (hereinafter, referred to as a PET film) having a thickness of 125 μm and by curing it.

### (Formation of Second Transparent Dielectric Layer)

A second transparent dielectric layer having a thickness of 20 nm was then formed by performing vacuum deposition of SiO₂ (refractive index n1=1.46) on the first transparent dielectric layer with an electron beam heating method at a degree of vacuum of 1×10⁻² to 3×10⁻² Pa.

### (Formation of Transparent Conductive Layer)

An ITO layer (refractive index n2=2.00) having a thickness of 22 nm was then formed, as the transparent conductive layer, on the second transparent dielectric layer with a reactive sputtering method using a sintered body material of 97% by weight of indium oxide and 3% by weight of tin oxide under an atmosphere of a mixed gas (0.4 Pa) of 98% of argon gas and 2% of oxygen gas.

### (Patterning of ITO Layer by Etching)

A photo resist film patterned in stripes was formed on the ITO layer, and then soaked in 5% by weight hydrochloric acid (a hydrogen chloride solution) at 25° C. for 1 minute to perform etching of the ITO layer. The pattern width of the obtained ITO layer was 5 mm and the pattern pitch thereof was 1 mm.

### (Patterning of Second Transparent Dielectric Layer by Etching)

A photo resist film was formed on all pattern portions of the ITO layer, and then soaked in a 2% by weight sodium hydroxide solution at 50° C. for 1 minute to perform etching of the second transparent dielectric layer directly under the pattern opening portion of the ITO layer. The pattern width of the obtained second transparent dielectric layer was 5 mm and the pattern pitch thereof was 1 mm.

### Examples 2 to 6

Transparent conductive films were obtained by performing the same operation as Example 1 except that the thicknesses of the first transparent dielectric layer and the second transparent dielectric layer in Example 1 were adjusted to values shown in Table 1.

### Example 7

A transparent conductive film was obtained by performing the same operation as Example 1 except that the first transparent dielectric layer in Example 1 was formed with the method shown below and the thickness of the transparent conductive layer (ITO layer) was 40 nm.

### (Method for Forming First Transparent Dielectric Layer in Example 7)

A first transparent dielectric layer (refractive index n0=2.35, thickness: 8 nm) consisting of titanium oxide was formed on one surface of the transparent base material (refractive index nf=1.66) consisting of a PET film having a thickness of 125 μm with a reactive sputtering method using a titanium target under an atmosphere of a mixed gas (0.5 Pa) of 50% of argon gas and 50% of oxygen gas.

### Comparative Examples 1 to 4

Transparent conductive films were obtained by performing the same operation as Example 1 except that the thicknesses of the first transparent dielectric layer and the second transparent dielectric layer in Example 1 were adjusted to values shown in Table 1.

### Comparative Example 5

A transparent conductive film was obtained by performing the same operation as Example 7 except that the thickness of the transparent conductive layer (ITO layer) in Example 7 was 55 nm.

### Comparative Example 6

A transparent conductive film was obtained by performing the same operation as Example 1 except that the thickness of the first transparent dielectric layer in Example 1 was 35 nm and the second transparent dielectric layer was not provided.

The above-described evaluation was performed on the transparent conductive films (samples) in the Examples and Comparative Examples. The results are shown in Table 1.

TABLE 1

| | FIRST TRANSPARENT | | | SECOND TRANSPARENT | | | TRANSPARENT CONDUCTIVE | | |
|---|---|---|---|---|---|---|---|---|---|
| | DIELECTRIC LAYER | | | DIELECTRIC LAYER | | | LAYER | | |
| | REFRAC- | | OPTICAL | REFRAC- | | OPTICAL | REFRAC- | | OPTICAL |
| | TIVE | THICKNESS | THICKNESS | TIVE | THICKNESS | THICKNESS | TIVE | THICKNESS | THICKNESS |
| | INDEX | (nm) | (nm) | INDEX | (nm) | (nm) | INDEX | (nm) | (nm) |
| Example 1 | 1.54 | 4 | 6 | 1.46 | 20 | 29 | 2.00 | 22 | 44 |
| Example 2 | 1.54 | 20 | 31 | 1.46 | 10 | 15 | 2.00 | 22 | 44 |
| Example 3 | 1.54 | 10 | 15 | 1.46 | 15 | 22 | 2.00 | 22 | 44 |
| Example 4 | 1.54 | 10 | 15 | 1.46 | 10 | 15 | 2.00 | 22 | 44 |
| Example 5 | 1.54 | 5 | 8 | 1.46 | 30 | 44 | 2.00 | 22 | 44 |
| Example 6 | 1.54 | 5 | 8 | 1.46 | 10 | 15 | 2.00 | 22 | 44 |
| Example 7 | 2.35 | 8 | 19 | 1.46 | 20 | 29 | 2.00 | 40 | 80 |
| Comparative | 1.54 | 30 | 46 | 1.46 | 20 | 29 | 2.00 | 22 | 44 |
| Example 1 | | | | | | | | | |
| Comparative | 1.54 | 5 | 8 | 1.46 | 35 | 51 | 2.00 | 22 | 44 |
| Example 2 | | | | | | | | | |
| Comparative | 1.54 | 150 | 231 | 1.46 | 35 | 51 | 2.00 | 22 | 44 |
| Example 3 | | | | | | | | | |
| Comparative | 1.54 | 180 | 277 | 1.46 | 33 | 48 | 2.00 | 22 | 44 |
| Example 4 | | | | | | | | | |
| Comparative | 2.35 | 8 | 19 | 1.46 | 20 | 29 | 2.00 | 55 | 110 |
| Example 5 | | | | | | | | | |

| | | | | | | | |
|---|---|---|---|---|---|---|---|
| Comparative | 1.54 | 35 | 54 | — | 2.00 | 22 | 44 |
| Example 6 | | | | | | | |

| | TRANSMIT- | | | | |
|---|---|---|---|---|---|
| | TANCE | | | | |
| | OF | DIFFERENCE | | | |
| | VISIBLE | IN | DIFFERENCE | | EVALUATION |
| | LIGHT | REFLECTANCE | IN HUES | | OF |
| | (%) | (%) | Δa* | Δb* | APPEARANCE |
| Example 1 | 89.8 | 0.72 | 0.25 | 3.35 | A |
| Example 2 | 89.7 | 1.17 | 0.23 | 4.42 | A |
| Example 3 | 89.6 | 1.00 | 0.20 | 3.40 | A |
| Example 4 | 89.3 | 1.38 | 0.05 | 3.31 | A |
| Example 5 | 90.6 | 0.38 | 0.60 | 4.80 | B |
| Example 6 | 89.0 | 1.60 | 0.00 | 3.10 | A |
| Example 7 | 83.4 | 5.38 | 0.60 | 4.46 | A |
| Comparative | 90.0 | 1.28 | 0.37 | 6.39 | C |
| Example 1 | | | | | |
| Comparative | 90.8 | 0.50 | 0.80 | 5.90 | C |
| Example 2 | | | | | |
| Comparative | 89.6 | 1.40 | 4.70 | 0.80 | C |
| Example 3 | | | | | |
| Comparative | 90.4 | 0.80 | 7.50 | 13.40 | C |
| Example 4 | | | | | |
| Comparative | 82.7 | 6.00 | 0.20 | 5.34 | C |
| Example 5 | | | | | |
| Comparative | 89.2 | 2.20 | 0.10 | 5.90 | C |
| Example 6 | | | | | |

As shown in Table 1, it has found that the Δa* value and the Δb* value are suppressed and a transparent conductive film having a good appearance is obtained in any of the Examples.

### EXPLANATION OF THE REFERENCE NUMERALS

1 TRANSPARENT BASE MATERIAL
2 FIRST TRANSPARENT DIELECTRIC LAYER
3 SECOND TRANSPARENT DIELECTRIC LAYER
4 TRANSPARENT CONDUCTIVE LAYER
5 TRANSPARENT PRESSURE-SENSITIVE ADHESIVE LAYER
6 TRANSPARENT SUBSTRATE
7 THIRD TRANSPARENT DIELECTRIC LAYER
10, 20, 30, 40, 50 TRANSPARENT CONDUCTIVE FILM
O PATTERN OPENING PORTION
P PATTERN PORTION

1. A transparent conductive film in which a first transparent dielectric layer and a transparent conductive layer are formed on a transparent base material in this order, wherein
a pattern portion and a pattern opening portion are formed on the transparent conductive layer by patterning, and
a relationship 0≦|a*_{P}−a*_{O}|≦4.00 is satisfied and a relationship 0≦|b*_{P}−b*_{O}|≦5.00 is satisfied where a hue a* value and a hue b* value of reflected light when the pattern portion is irradiated with white light are a*_{P} and b*_{P}, respectively, and a hue a* value and a hue b* value of reflected light when a portion directly under the pattern opening portion is irradiated with white light are a*_{O} and b*_{O}, respectively.

2. The transparent conductive film according to claim 1, further having a second transparent conductive layer that is provided between the first transparent dielectric layer and the transparent conductive layer, and that has a refractive index different from that of the first transparent conductive layer.

3. The transparent conductive film according to claim 2, wherein
the optical thickness of the first transparent dielectric layer is 3 to 45 nm,
the optical thickness of the second transparent dielectric layer is 3 to 50 nm,
the optical thickness of the transparent conductive layer is 20 to 100 nm, and
a relationship n1<n2 is satisfied where the refractive index of the second transparent dielectric layer is n1 and the refractive index of the transparent conductive layer is n2.

4. The transparent conductive film according to claim 2, wherein a pattern portion and a pattern opening portion are formed by patterning on the second transparent dielectric layer.

5. The transparent conductive film according to claim 3, wherein a pattern portion and a pattern opening portion are formed by patterning on the second transparent dielectric layer.

6. The transparent conductive film according to claim 4, wherein the pattern portion of the transparent conductive layer and the pattern portion of the second transparent dielectric layer are matched to each other.

7. The transparent conductive film according to claim 5, wherein the pattern portion of the transparent conductive layer and the pattern portion of the second transparent dielectric layer are matched to each other.

8. A touch panel comprising the transparent conductive film according to claim 1.
